(19) United States
(12) Patent Application Publication
(10) Pub. No.: US 2009/0002991 A1
(43) Pub. Date: Jan. 1, 2009

(54) Decorative light string

(76) Inventor: Kuo-Hao Huang, Taipei (TW)

Correspondence Address: COOPER & DUNHAM, LLP, 1185 AVENUE OF THE AMERICAS, NEW YORK, NY, 10036, US

(21) Appl. No.: 11/823,749

(22) Filed: Jun. 28, 2007

(51) Int. Cl. F21S 4/00

(52) U.S. Cl. 362/252

(57) ABSTRACT

A decorative light string has multiple light units connected to a power wire. Each of the light units has a base, a holder, a lighting element and a stopper. The base has a channel that allows the power wire to extend through the base. The holder is formed on the base. The lighting element is mounted in the holder and has two conductive pins extending through the holder and the base to electronically contact the power wire. The stopper is mounted in the base to prevent the power wire from detaching from the base.

### BACKGROUND OF THE INVENTION

1. Field of the Invention

The present invention relates to a decorative light string, and more particularly to a decorative light string that can be easily manufactured and assembled by machines to reduce manual operations.

2. Description of Related Art

With reference to FIG. 5, a conventional decorative light used in a light string comprises a socket (50), a light holder (52) and a light bulb (54). The decorative light is electronically connected to two wires (56). The socket (50) may be a cylinder body and has a hole (501) formed coaxially through the cylinder body. Each of the two wires (56) has a conductor (561) extending into the hole (501) and being mounted in the hole (501). The light holder (52) is mounted in the socket (50) for holding the light bulb (54). The light bulb (54) has two conductive pins (541) being bent to electronically contact the two conductors (561) respectively. The drawback of the convention decorative light is that the wires (56) must be manually inserted into the socket (50) and unable to be automatically assembled by machines. The cost and time for manufacturing the light string will accordingly increase.

With reference to FIG. 6, another conventional decorative light of a light string suitable is composed of a socket (60), a light holder (62), a light bulb (64) having two conductive pins (641), and a bottom base (66). The decorative light is connected to power wires (68). Each wire (68) has a proximal end formed with a conductor (681). The socket (60) has a cylinder body with a through hole (601) and a flange (602) integrally extended from the cylinder body. The light holder (62) is mounted in the through hole (601) of the socket (60) to hold the light bulb (64). The two wires (68) can be firmly clipped by the flange (602) and the bottom base (66) when the conductors (681) are assembling in the through hole (601) of the cylinder body to electronically contact the two conductive pins (641) of the light bulb (64). Although the decorative light is suitable to be automatically assembled by machines, the large size and complex structures of the socket (60) become new problems to be solved.

To overcome the foregoing shortcomings, the present invention provides a decorative light string to mitigate or obviate the aforementioned problems.

### SUMMARY OF THE INVENTION

The main objective of the invention is to provide a decorative light string that can be easily assembled and fabricated with machines.

A decorative light string has multiple light units connected to a power wire. Each of the light units has a base, a holder, a lighting element and a stopper. The base has a channel that allows the power wire to extend through the base. The holder is formed on the base. The lighting element is mounted in the holder and has two conductive pins extending through the holder and the base to electronically contact the power wire. The stopper is mounted in the base to prevent the power wire from detaching from the base.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a decorative light string in accordance with the present invention;

FIG. 2 is an exploded perspective view of a decorative light of the decorative light string in accordance with the present invention;

FIG. 3 is a perspective view of the decorative light of FIG. 2;

FIG. 4 is a partial cross-sectional view of the decorative light of FIG. 3;

FIG. 5 is an exploded perspective view of a decorative light of the decorative light string of a second embodiment in accordance with the present invention;

FIG. 6 is an exploded perspective view of a decorative light of the decorative light string of a third embodiment in accordance with the present invention;

FIG. 7 is a partial cross-sectional view of a conventional decorative light; and

FIG. 8 is a partial cross-sectional view of another conventional decorative light.

### DETAILED DESCRIPTION OF PREFERRED EMBODIMENT

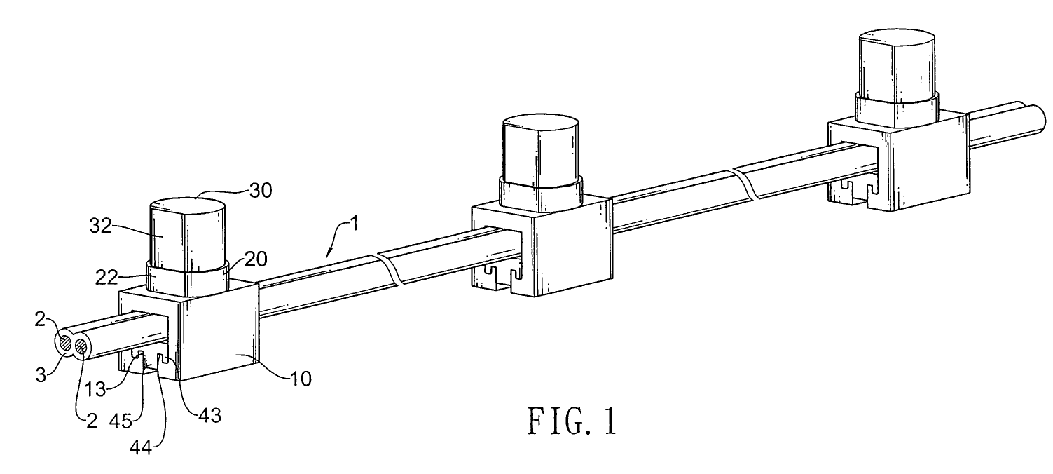

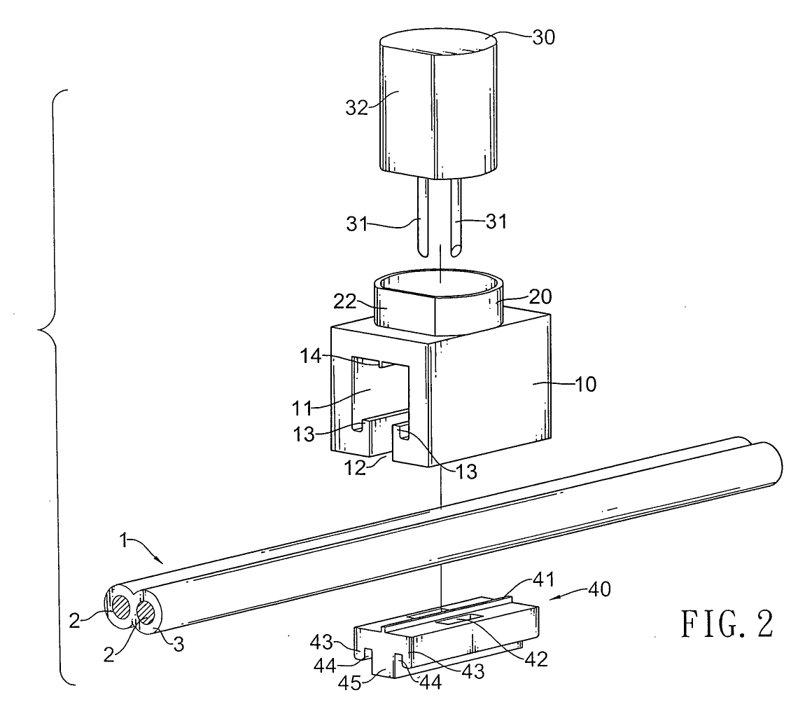

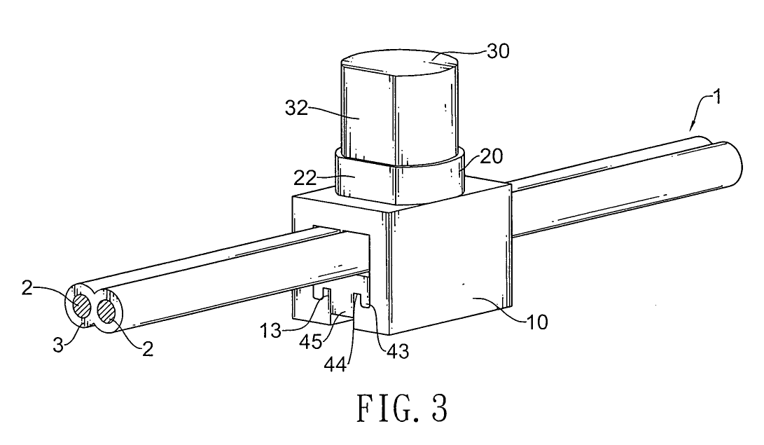

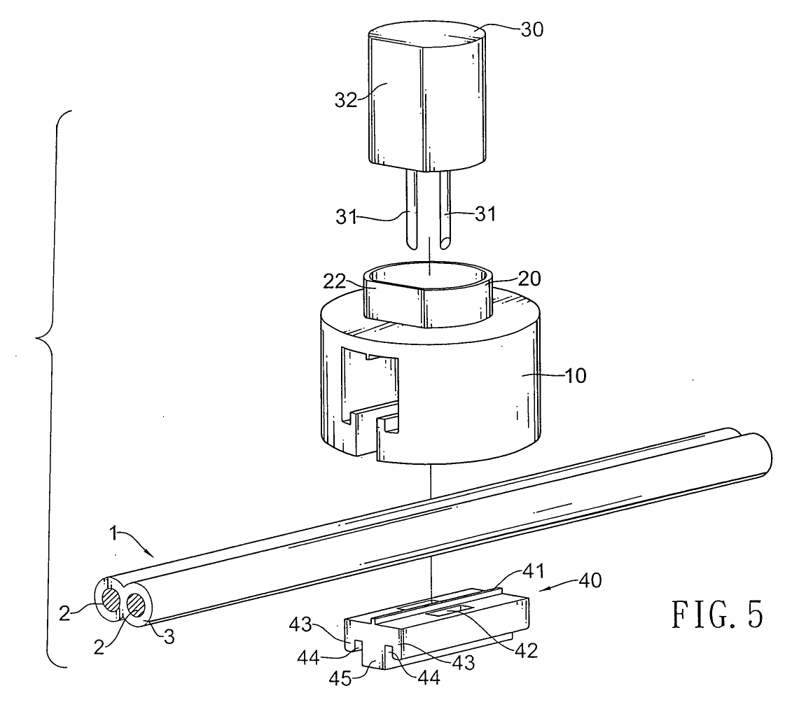

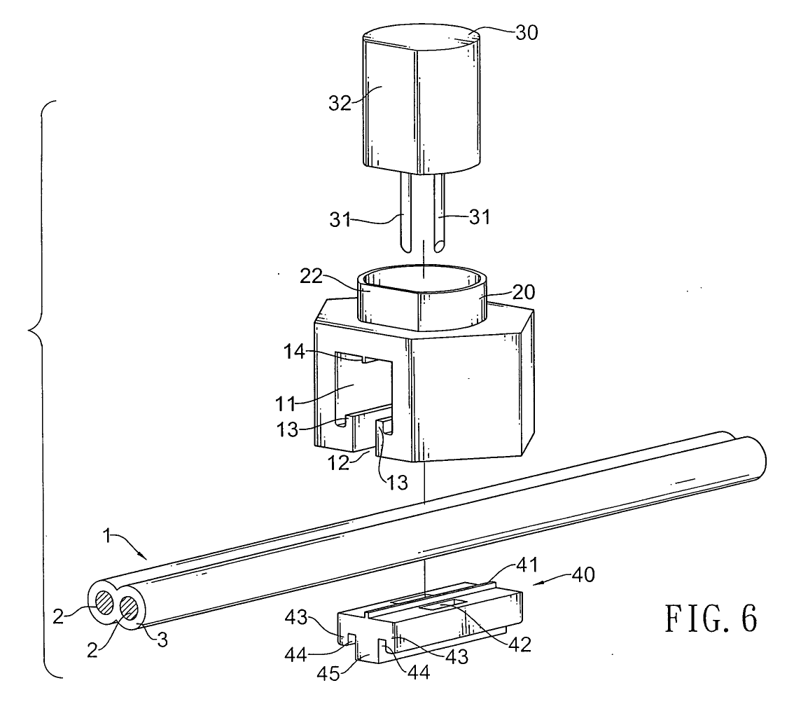

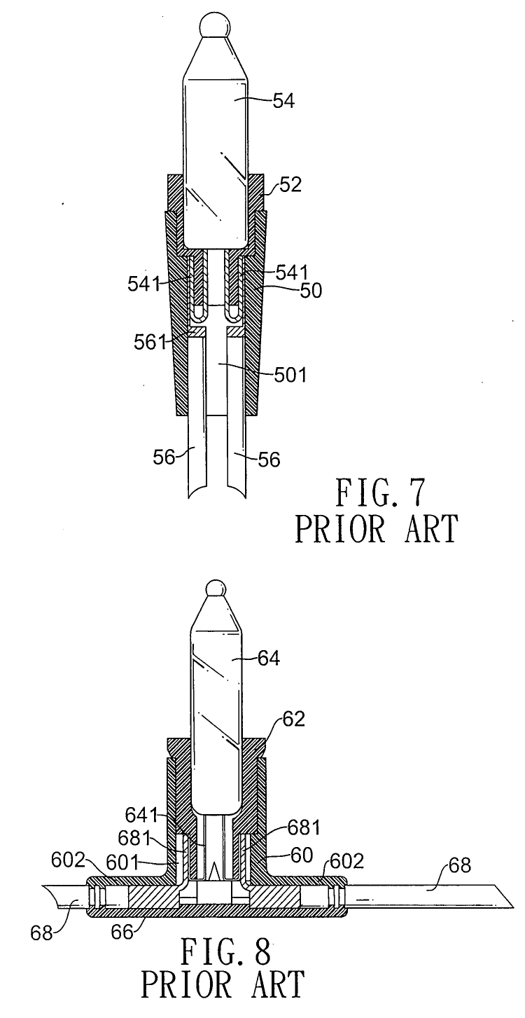

With reference to FIGS. 1 to 3 and 5-6, a decorative light string in accordance with the present invention is composed of a power wire (1) and multiple light units connected to the power wire (1). The power wire (1) is formed by two cores (2) enclosed by an isolating coating (3) but the two cores (2) are separated from each other.

Each of the light units comprises a base (10), a holder (20), a lighting element (30) and an optional stopper (40).

The base (10) can be formed to have a three dimensional shape, such as a cube, a cylinder, a hexagonal column or such like. The base (10) comprises a top, a channel (11), a slot (12), two rails (13) and an upper rib (14). The channel (11) is laterally formed through the base (10) and through which the power wire (1) passes. The channel (11) having an inner top surface and an inner bottom. The slot (12) is defined through the inner bottom of the channel (11) and communicated with the channel (11). The power wire (1) can be pushed into the channel (11) through the slot (12) and then be mounted in the channel (11). The two rails (13) are respectively formed on opposite sides of the slot (12) and protruding toward the upper rib (14). The upper rib (14) is formed on the inner top surface of the channel (11) to abut against the power wire (1).

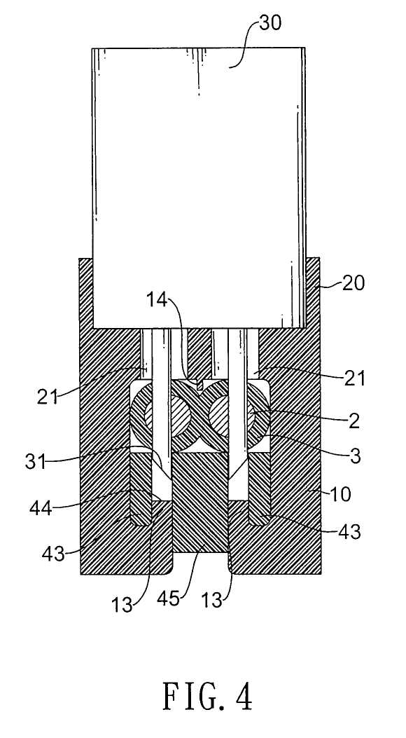

With further reference to FIG. 4, the holder (20) is integrally formed on the top of the base (10) and communicates with the channel (11) by two apertures (21) defined through the top of the base (10). The holder (20) forms an orientating plane (22) to guide the lighting element (30) being mounted in the holder (20) in a correct position.

The lighting element (30) can be a light emitting diode (LED) and has two truncated conductive pins (31) that pierce through the isolating coating (3) of the power wire (1) to electronically and respectively contact the two cores (2). The lighting element (30) forms a guiding plane (32) accommodating to the orientating plane (22) to prevent the light element (30) from incorrectly mounting in the holder (20).

The stopper (40) has a top surface, a bottom surface with two opposite edges, a lower rib (41), two openings (42), two flanges (43), two grooves (44) and a protrusion (45). The lower rib (41) protrudes from the top surface of the stopper (40) to abut against the power wire (1). The two flanges (43) respectively extend downward along the two opposite edges of the bottom surface. The protrusion (45) is formed on the bottom surface and between the two flanges (43) to define the two grooves (44). The two grooves (44) are respectively engaged with the two rails (13) of the base (10) when the protrusion (45) is mounted in the slot (12) to prevent the power wire (1) from detaching from the base (10). The two conductive pins (31) of the lighting element (30) further respectively extend into the two openings (42).

The simple structures of foregoing elements make the machines assemble the light units automatically and improve the manufacturing efficiency. As a result, manual works can be greatly reduced. In addition to a steady mode that the light units are always turned on, the multiple light units can be operated in different modes to generate visual effects such as flashing or chasing effects. To generate the chasing effect, the light units are sequentially turned on and turned off.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A decorative light string comprising:
multiple light units connected to a power wire that comprises two cores enclosed by an isolating coating;
each of the light units comprising:
a base having a channel defined through the base and through which the power wire passes;
a holder formed on the base and having an orientating plane;
a lighting element having
a guiding plane corresponding to the orientating plane and making the lighting element correctly mounted in the holder; and
two conductive pins extending through the holder to electronically and respectively contact the two cores of the power wire.

2. The decorative light string as claimed in claim 1, each of the light units further comprising a stopper mounted in the base and preventing the power wire from detaching from the base.

3. The decorative light string as claimed in claim 1, wherein:
the channel has an inner top surface and an inner bottom; and
the base further comprises:
an upper rib formed on the inner top surface and abutting against the power wire;
a slot defined through the inner bottom of the channel and communicating with the channel; and
two rails formed respectively on opposite sides of the slot and protruding toward the upper rib.

4. The decorative light string as claimed in claim 2, wherein:
the channel has an inner top surface and an inner bottom; and
the base further comprises:
an upper rib formed on the inner top surface and abutting against the power wire;
a slot defined through the inner bottom of the channel and communicating with the channel; and
two rails formed respectively on opposite sides of the slot and protruding toward the upper rib.

5. The decorative light string as claimed in claim 3, the stopper further comprising:
a top surface;
a bottom surface with two opposite edges;
a lower rib protruding from the top surface and abutting against the power wire;
two flanges respectively extending downward and along the two opposite edges of the bottom surface;
a protrusion formed on the bottom surface and between the two flanges to define two grooves that respectively engage with the two rails of the base when the protrusion is mounted in the slot; and
two apertures defined through the stopper, and the conductive pins of the lighting element respectively extend into the two apertures.

6. The decorative light string as claimed in claim 4, the stopper further comprising:
a top surface;
a bottom surface with two opposite edges;
a lower rib protruding from the top surface and abutting against the power wire;
two flanges respectively extending downward and along the two opposite edges of the bottom surface;
a protrusion formed on the bottom surface and between the two flanges to define two grooves that respectively engage with the two rails of the base when the protrusion is mounted in the slot; and
two apertures defined through the stopper, and the conductive pins of the lighting element respectively extend into the two apertures.

7. The decorative light string as claimed in claim 5, wherein the base is formed to have a three dimensional shape.

8. The decorative light string as claimed in claim 6, wherein the base is formed to have a three dimensional shape.

9. The decorative light string as claimed in claim 7, wherein the three dimensional shape is a cube, a cylinder or a hexagonal column.

10. The decorative light string as claimed in claim 8, wherein the three dimensional shape is a cube, a cylinder or a hexagonal column.

11. The decorative light string as claimed in claim 7, wherein the light units are always turned on.

12. The decorative light string as claimed in claim 8, wherein the light units are always turned on.

13. The decorative light string as claimed in claim 7, wherein the light units are controlled to generate visual effects of flashing or chasing.

14. The decorative light string as claimed in claim 8, wherein the light units are controlled to generate visual effects of flashing or chasing.
